(19) United States
(12) Patent Application Publication
(10) Pub. No.: US 2010/0266290 A1
(43) Pub. Date: Oct. 21, 2010

(54) LASER COMMUNICATION POSITIONING SYSTEM

(75) Inventors: Halil N. Altan, Heathrow, FL (US); Robert Burns, St. Petersburg, FL (US); John Ryan Parry, Safety Harbor, FL (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/424,237

(22) Filed: Apr. 15, 2009

(51) Int. Cl. H04B 10/00; G01J 1/00

(52) U.S. Cl. 398/156; 356/213

(57) ABSTRACT

A system for receiving an optical communication signal includes a first array of light responsive devices defining a first target area and a second light responsive device defining a second target area. The second target area is smaller than the first target area. A detection device is coupled to the first array of light responsive devices and configured to identify at least one individual light responsive device in the first array of light responsive devices receiving the greatest light input relative to other light responsive devices in the first array of light responsive devices. A positioning device is configured to position the second light responsive device relative to the at least one individual light responsive device, such that the second light responsive device receives the optical communication signal.

### BACKGROUND

Laser communication is becoming more prevalent in various communication scenarios. The acronym laser stands for “light amplification by stimulated emission of radiation.” Lasers are focused beams of electromagnetic radiation, including both visible and non-visible light, created through the process of stimulated emission.

Laser communication systems implement narrow beam widths and are more focused and directional than radio waves. The highly focused laser beams used in laser communication have desirable properties, such as reducing the interference common to radio wave communication signals. Specifically, laser communication signals are less susceptible to multipath interference. Laser beams are also highly efficient in the transmission of data. Because laser beams have little divergence, high beam intensities are maintained over large distances, resulting in little power loss from the source of the laser beam to the output of the laser beam.

A typical laser communication network requires at least one transmitter at one end of the communication link and at least one receiver at the other end. Laser communication networks typically include both a transmitter and receiver, or a transceiver, at each end of the laser communication link, allowing for communication in both directions.

An example laser communication system may have an optical antenna with a diameter 100 times smaller than an example radio wave communication system. An example optical antenna used in a laser communication system may have a target area smaller than 10 cm in diameter. The combination of the small size of the target and the narrowness of the laser beams used in laser communications can make positioning of the transmitters and receivers for proper acquisition and tracking of the laser beam a difficult task. It is particularly difficult as the distances between the transmitting and receiving devices become greater.

### SUMMARY

A system for receiving an optical communication signal includes a first array of light responsive devices defining a first target area and a second light responsive device defining a second target area. The second target area is smaller than the first target area. A detection device is coupled to the first array of light responsive devices and configured to identify at least one individual light responsive device in the first array of light responsive devices receiving the greatest light input relative to other light responsive devices in the first array of light responsive devices. A positioning device is configured to position the second light responsive device relative to the at least one individual light responsive device, such that the second light responsive device receives the optical communication signal.

The details of various embodiments of the claimed invention are set forth in the accompanying drawings and the description below. Other features and advantages will become apparent from the description, the drawings, and the claims.

### DRAWINGS

FIG. 1 is a diagram of one embodiment of a laser communication positioning system according to the present disclosure and before positioning is commenced.

FIG. 2 is a diagram of the laser positioning system of FIG. 1 after positioning is completed.

FIG. 3 is a diagram of another embodiment of a laser communication positioning system according to the present disclosure and before positioning is commenced.

FIG. 4 is a diagram of the laser positioning system of FIG. 3 after positioning is completed.

FIG. 5 is a diagram of one embodiment of a laser communication network according to the present disclosure and before positioning is commenced.

FIG. 6 is a diagram of the laser communication network of FIG. 5 after positioning is completed.

FIG. 7 is a diagram of another embodiment of a laser communication positioning system according to the present disclosure and before positioning is commenced.

FIG. 8 is a diagram of the laser positioning system of FIG. 7 after positioning is completed.

FIG. 9 is a flow chart showing one embodiment of a method for positioning a laser communication device.

Like reference numbers and designations in the various drawings indicate like elements.

### DETAILED DESCRIPTION

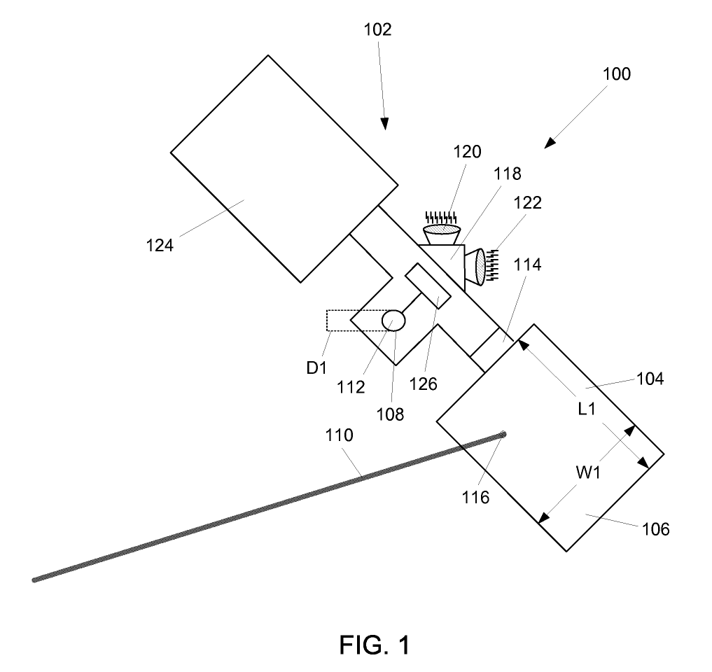

Spacecraft often obtain energy from solar cell arrays. Solar cell arrays provide electrical power from sunlight. Solar cell arrays are typically quite large, causing multipath interference to radio wave signals. Generally, this disclosure describes the modification of large solar cell arrays to report the position at which a laser or other optical communication beam hits a solar cell array and the use of this position information to reposition an optical receiver to properly receive the laser or other optical communication beam. FIGS. 1-9 and the following description show and describe particular embodiments of laser communication positioning systems and networks and methods for positioning a laser communication device.

FIG. 1 is a diagram of one embodiment of a laser communication positioning system 100 implemented as part of a satellite 102. The laser communication positioning system 100 includes a first array 104 of solar cells (photovoltaic cells). In other embodiments, other light responsive devices are used in the first array 104, such as photodiodes, optical collectors, various transceivers, and other light sensors. In the embodiment shown, the first array 104 is a solar collection panel (solar array), but arrays of other light responsive devices are used in other embodiments. One purpose of the first array 104 of solar cells is to collect and store electrical power from sunlight, which is used to power the operation of the satellite 102. As mentioned earlier and discussed in detail below, the first array 104 of solar cells is also used as a larger target to guide the proper positioning of an optical receiver.

The first array 104 shown in FIG. 1 has a length L1 of between about 3 meters (about 10 feet) and about 9 meters (about 30 feet), but other embodiments of first array 104 have greater or smaller lengths. The first array 104 shown in FIG. 1 has a width W1 of between about 3 meters (about 10 feet) and about 9 meters (about 30 feet), but other embodiments of the first array 104 have greater or smaller widths. Thus, the first array 104 has a target area 106 that is between about 10 square meters (about 100 square feet) and about 81 square meters (about 900 square feet). Other embodiments have a greater or smaller target area 106. For example, example embodiments could be configured to operate on the International Space Station (“ISS”), which has solar arrays that span about 3,500 square meters (about 37,600 square feet).

The laser communication positioning system 100 further includes an optical receiver 108 configured to receive a laser beam 110 carrying a communication signal. The optical receiver 108 is a light responsive device. In example embodiments, the optical receiver 108 is an optical antenna. Other embodiments are configured to receive other optical communication signals other than laser beams. The optical receiver 108 has a diameter D1 of between about 1 centimeter (about 0.5 inches) and about 1 meter (about 3 feet), and preferably between about 5 centimeters (about 2 inches) and about 50 centimeters (about 20 inches). Other embodiments of the optical receiver 108 have greater or smaller diameters. Thus, the optical receiver 108 has a target area 112 that is between about 1 square centimeter (about 0.2 square inches) and about 1 square meter (about 10 square feet), and preferably between about 20 square centimeters (about 3 square inches) and about 250 square centimeters (about 39 square inches). In example embodiments, the target area 106 of the first array 104 is between about 3 times and about 8000 times larger than the target area 112 of optical receiver 108, and preferably between about 20 times and about 200 times larger. In example embodiments, the optical receiver 108 is an optical antenna designed for a narrow beam width laser, such as a parabolic reflector antenna. In example embodiments, the laser beam 110 has a narrow beam width, typically between about 1 microradian (about 57 microdegrees) and about 100 microradians (about 5.7 millidegrees), and preferably between about 25 microradians (about 1.4 millidegrees) and about 50 microradians (about 2.8 millidegrees).

The first array 104 of the system 100 shown in FIG. 1 is the same solar cell array used to gather energy from the sun and other light sources to power the satellite 102. In other embodiments, a different array is used. As mentioned above, the first array 104 and other solar cell arrays are typically quite large in comparison to other components of the satellite 102. In other satellites not including system 100, solar cell arrays tend to block the direct line of sight necessary for optical/laser communication from a signal source, such as another satellite or ground based installation.

In the embodiment of the satellite shown in FIG. 1 implementing the system 100, the large first array 104 is converted from being an obstacle to avoid to a larger target to aim the laser beam 110 toward. Generally, as the laser beam 110 strikes the target area 106 of the first array 104, the system 100 determines precisely where the laser beam 110 strikes the target area 106 of the first array 104. The system 100 then positions the smaller target area 112 of the optical receiver 108 to properly receive the laser beam 110 based on where the laser beam 110 strikes the larger target area 106 of the first array 104.

Specifically, the laser communication positioning system 100 further includes a detection device 114 coupled with the first array 104. In example embodiments, the detection device 114 is configured to determine which subset of light responsive devices 116 in the first array 104 receives the greatest light input relative to the other light responsive devices in the first array 104. In some embodiments, the subset of light responsive devices 116 is a single light responsive device. In other embodiments, the subset of light responsive devices 116 is a group of light responsive devices. In some embodiments, the detection device 114 is incorporated into a centralized computing device or implemented in another manner. In some embodiments, the actual location of the subset of light responsive devices 116 on the first array 104 is determined. In other embodiments, the actual location is not explicitly determined, but the subset of light responsive devices 116 is identified in other ways.

Some or all of the light responsive devices in the first array 104 typically receive light input from other sources, such as the Sun, stars, or reflections from planets, planetoids, satellites, and other celestial objects. The laser beam 110 is typically a highly focused and powerful beam of light. In some embodiments, even if the solar panels are receiving solar light simultaneously to receiving the laser beam 110, the laser beam 110 provides additional light to the subset of light responsive devices 116 in the first array 104, such that more total light is received at the subset of light responsive devices 116 is identified as receiving the laser beam 110 because it receives the greatest light input relative to the other light responsive devices in the first array 104. In some embodiments, the precise location of the subset of light responsive devices 116 is delineated by a Cartesian coordinate system having x, y, and z coordinates. In other examples, the location is delineated using other methods, such as a Polar, Cylindrical, or Spherical coordinate system or a two dimensional Cartesian coordinate system having only x and y coordinates. As discussed above, particular embodiments identify the subset of light responsive devices 116 that receive the greatest light input relative to the other light responsive device in the first array 104 without explicitly identifying or delineating the location.

The detection device 114 can be implemented in a variety of ways. In example embodiments, additional wiring is included and configured in the first array 104 to identify the subset of light responsive devices 116 that receive the laser beam 110. The additional wiring is typically configured so that the light current coming through each individual light responsive device in the first array 104 can be precisely measured by the detection device 114. The detection device 114 uses the measurements of light current for the individual light responsive devices in the first array 104 to identify which subset of light responsive device 116 receive the laser beam 110. In some embodiments, the laser communication positioning system 100 only operates while the first array 104 is not generating solar power, in order to avoid interference and noise from the solar power generation. In other embodiments, various transceivers (optical collectors) or other laser sensors are added to the first array 104 between individual cells or additional light sensors are added to the first array 104 in various locations to identify the subset of light responsive devices 116 that receive the laser beam 110. In other embodiments, other ways of identifying the subset of light responsive devices 116 that receive the laser beam 110 are implemented into system 100.

The laser communication positioning system 100 further includes a positioning device 118 configured to position the optical receiver 108. Specifically, the positioning device 118 aligns the optical receiver 108 to receive laser beam 110, by positioning the optical receiver relative to the subset of light responsive devices 116 identified by the detection device 114. In embodiments where the location of the subset of light responsive devices is explicitly identified, the optical receiver 108 is positioned at or near the location of the subset of light responsive devices 116 by positioning device 118.

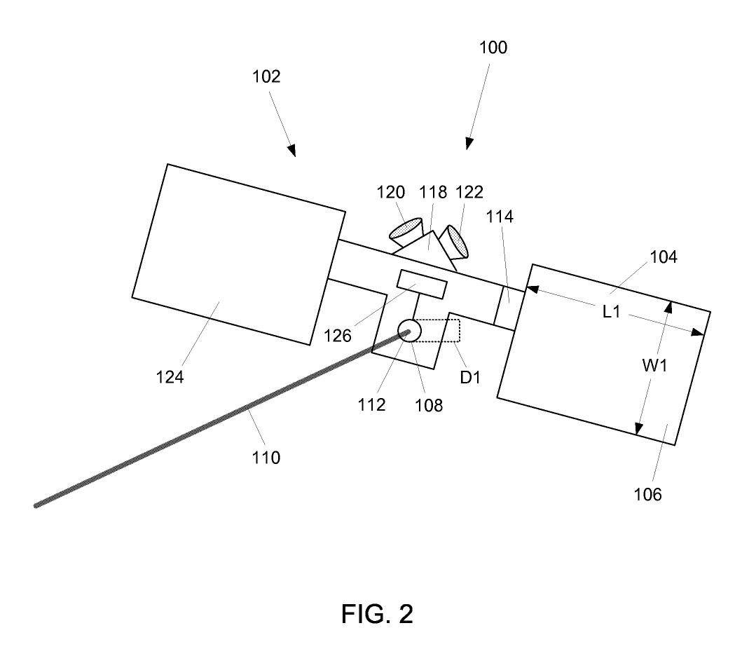

In some embodiments, such as the embodiment shown in FIG. 1, the positioning device 118 repositions the optical receiver 108 relative to the laser beam 110 by reorienting the entire satellite 102 (changing the attitude of the satellite), and thus the entire system 100. As mentioned above, the system 100 shown in FIG. 1 is implemented as part of a satellite 102 positioned in space. The attitude/orientation of the entire satellite 102 is reoriented to properly position the optical receiver 108 to receive the laser beam 110. The positioning device 118 includes a first thruster 120 and a second thruster 122 configured to adjust the attitude/orientation of the entire satellite. Other embodiments only have a single thruster or more than two thrusters. In other embodiments, the positioning device 118 includes other propulsion devices. The first thruster 120 and the second thruster 122 reorient the entire satellite 102, and thus the entire system 100, such that optical receiver 108 receives the laser beam 110 as is shown in FIG. 2 and discussed below.

The example satellite 102 of FIG. 1 includes a second array 124 of solar cells or other light receiving devices. In example embodiments, the second array 124 is also used to determine where the optical receiver 108 should be positioned to receive the laser beam 110. In example embodiments, the detection device 114 (or a second similar detection device) is used to determine which subset of light responsive devices 116 receives the greatest light input relative to the other light responsive devices in both the first array 104 and the second array 124. In example embodiments, the second array 124 has similar dimensions and target areas as the first array 104, but in other embodiments the second array 124 is larger or smaller. In other embodiments, more arrays of solar cells or other light receiving devices can be used in a similar way to provide input to guide in positioning the optical receiver 108 to receive the laser beam 110.

The system 100 also includes a signal processing device 126 that processes the communication signal carried in the laser beam 110 received by the optical receiver 108. The signal processing device 126 is coupled with the optical receiver 108 in an appropriate manner, such as through a communication cable embedded in the satellite 102, a wireless radio device, or with a free space optical transmission, such as a laser communication beam. Information received through the communication signal carried in the laser beam 110 is used for various purposes used in satellites, such as for control, communication relay, and information gathering.

FIG. 2 is a diagram of the laser communication positioning system 100 after it is positioned so that the optical receiver 108 properly receives the laser beam 110. The first thruster 120 and the second thruster 122 reorient the entire system 100 by reorienting the satellite 102 based on the information gathered by the detection device 114. The various components of the system 100 are used to maintain proper positioning of the optical receiver 108 to receive the laser beam 110.

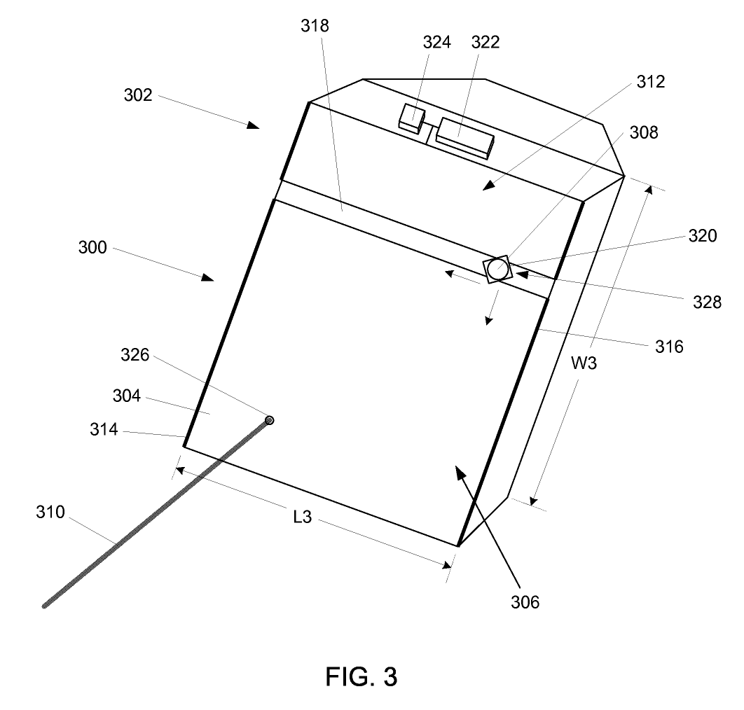

FIG. 3 is a diagram of another embodiment of the laser communication positioning system 300 implementing a different way of positioning an optical receiver than in the embodiment shown in FIGS. 1-2 and described above. The system 300 is similar to the system 100 shown in FIGS. 1-2. Specifically, the system 300 is also implemented as part of a satellite 302. The system 300 includes a first array 304 of light receiving devices, such as a solar cell array. In example embodiments, a length L3 of system 300 falls in the same ranges described with regard to length L1 of system 100 and a width W3 of system 300 falls in the same ranges described with regard to width W3 of system 300. Thus, the first array 304 has a target area 306 that is between about 36 square meters (about 400 square feet) and about 81 square meters (about 900 square feet), similar to target area 106 of first array 104. In other examples, the target area 306 is larger or smaller.

The system 300 also includes an optical receiver 308 configured to receive a laser beam 310 carrying a communication signal. The optical receiver 308 is a light responsive device. In example embodiments, the optical receiver 308 is an optical antenna. The optical receiver 308 is disposed on a track and rail system 312. The track and rail system 312 includes a first track 314 placed on a first side of the first array 304, and a second track 316 placed on a second side of the first array 304 opposite the first side, such that the first track 314 and the second track 316 are parallel with each other. A sliding rail 318 is slidably coupled to the first track 314 on one end and to the second track 316 on the other end.

The track and rail system 312 further includes an optical receiver housing 320 slidably coupled to the sliding rail 318. The optical receiver 308 is disposed in the optical receiver housing 320 and coupled with a signal processing device 322 that processes the communication signal carried in the laser beam 310 received by the optical receiver 308. In some examples, the optical receiver 308 is coupled to the signal processing device 322 through wires or other coupling means embedded in the track and rail system 312. In other examples, the optical receiver 308 is coupled to the signal processing device 322 in other suitable ways that do not restrict movement of the optical receiver 308 in the optical receiver housing 320, such as by wireless radio devices, or with free space optical transmission, such as a laser communication beam. Information received through the communication signal carried in the laser beam 310 is used for any number of purposes used in satellites, such as for control, communication relay, and information gathering. Because of the design of the track and rail system 312 and the optical receiver housing 320, the optical receiver 308 is movable in all directions in the two dimensional plane above the first array 304. In other embodiments, the optical receiver 308 is movable in other directions and on other planes.

The track and rail system 312, including the first track 314, the second track 316, the sliding rail 318, and the optical receiver housing 320 is typically made of strong materials, such as steel, aluminum, titanium, and other metals. In other examples, the track and rail system 312 is made from other suitable materials, such as plastics, carbon fiber, and other composites. The track and rail system 312 is typically as thin and low profile as possible in order to minimize blockage or deflection of sunlight or the laser beam 310. In some embodiments, the first array 304 is configured to be in both opened and closed positions. In these examples, the track and rail system 312 is configured to fold and collapse with the first array 304 when it is in the closed position and to unfold and expand with the first array 304 when it is in the opened position. In other embodiments, the track and rail system 312 includes different numbers of tracks and rails.

The system 300 further includes a detection device 324 coupled with the first array 304 and configured to determine which subset of light responsive devices 326 in the first array 304 receives the greatest light input relative to the other light responsive devices in the first array 304. In some embodiments, the subset of light responsive devices 326 is a single light responsive device. In other embodiments, the subset of light responsive devices 326 is a group of light responsive devices. In some embodiments, the detection device 324 is incorporated into a centralized computing device or implemented in another manner. In some embodiments, the actual location of the subset of light responsive devices 326 on the first array 304 is determined. In other embodiments, the actual location is not explicitly determined, but the subset of light responsive devices 326 is identified in other ways.

The system 300 also includes at least one positioning device 328 configured to position the optical receiver 308 in the optical receiver housing 320. Specifically, the at least one positioning device 328 aligns the optical receiver 308 to receive the laser beam 310, by positioning the optical receiver 308 relative to the subset of light responsive devices 326. In embodiments where the location of the subset of light responsive devices 326 is identified, the at least one positioning device 328 positions the optical receiver 308 at or near the location of the subset of light responsive devices 326. In other embodiments where the location of the subset of light responsive devices 326 is not explicitly identified, the at least one positioning device 328 positions the optical receiver 308 to receive the laser beam 310 in other ways.

In system 300, the at least one positioning device 328 positions the optical receiver 308, by sliding the sliding rail 318 on the first track 314 and the second track 316 and by sliding the optical receiver housing 320 on the sliding rail 318. In example embodiments, the positioning device includes at least one motor configured to move the sliding rail 318 along the first track 314 and the second track 316 and at least one motor configured to move the optical receiver housing 320 along the sliding rail 318. Specifically, a first motor moves the optical receiver housing 320 on the sliding rail 318 and a second and third motor moves the sliding rail along first track 314 and second track 316 respectively. Thus, the optical receiver 308 in the optical receiver housing 320 is configured to be positioned on the two dimensional plane above any of the individual light responsive devices in the first array 304. In other embodiments, other amounts of motors are used or other devices and mechanisms are provided to reposition the optical receiver 308 in the optical receiver housing 320. In particular embodiments, the at least one positioning device 328 includes other mechanical solutions, such as a spiraling or rolling shaft or cylinder with groves catching a rotating shaft, or a pneumatic or hydraulic system configured to position the optical receiver in the optical receiver housing 320 at various locations in the plane above the first array 304.

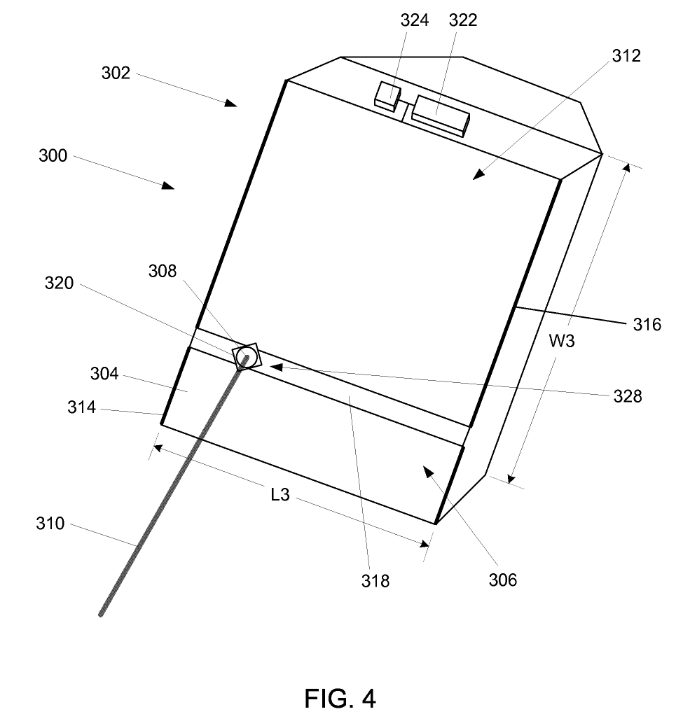

FIG. 4 is a diagram of the laser communication positioning system 300 positioned so that the optical receiver 308 properly receives the laser beam 310. The optical receiver 308 is positioned by at least one positioning device 328 based on the information gathered by detection device 324. In some examples, the at least one positioning device 328 includes a plurality of motors configured to move the sliding rail 318 along the first track 314 and the second track 316 and to move optical receiver housing 320 along the length of the sliding rail 318. The optical receiver 308 is positioned such that it is intercepts the laser beam 310 striking the subset of light responsive devices 326 in the first array 304 that receives the greatest light input relative to the other light responsive devices in the first array 304. The system 300 will constantly monitor the position of the optical receiver 308 to ensure that it is properly receiving the laser beam 310. Other example embodiments position the optical receiver 308 in other ways, instead of using the track and rail system 312 described above.

Though the embodiments shown in FIGS. 1-2 and FIGS. 3-4 implement different ways for positioning optical receiver 108 and optical receiver 308 respectively, other embodiments combine these and other ways of positioning the optical receiver. In some embodiments, an optical receiver is properly positioned using both reorientation of the entire system using propulsion devices and movement of the optical receiver relative to a first array of the system using tracks and rails. In other examples, other methods of repositioning the optical receiver are used, such as pivoting the optical receiver or extending it on a mechanical arm.

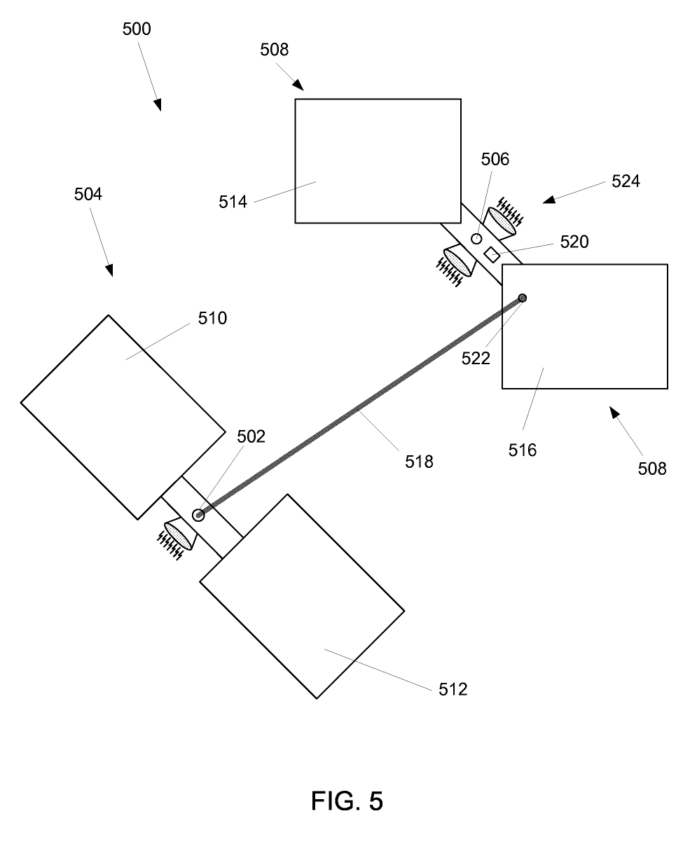

FIG. 5 is a diagram of an embodiment of a laser communication network 500 according to the present disclosure before positioning is commenced. The laser communication network 500 includes a transmitter 502 disposed on a first satellite 504 and a receiver 506 disposed on a second satellite 508. The first satellite 504 has a first solar panel array 510 and a second solar panel array 512. The second satellite 508 has a first solar panel array 514 and a second solar panel array 516. Both the first satellite 504 and the second satellite 508 can have greater or fewer amounts of solar panel arrays. The solar panel arrays can be a variety of sizes and shapes with various target areas, as described above regarding the embodiments shown in FIGS. 1-4.

The transmitter 502 emits a laser beam 518 carrying a communication signal. In example embodiments, the laser beam 518 is directed toward the receiver 506 of the second satellite 508, but the laser beam 518 instead hits the second solar panel array 516 on the second satellite 508. The second satellite 508 has a detection device 520 configured to determine where, on either the first solar panel array 514 or the second solar panel array 516, the laser beam 518 strikes. This is described above in greater detail with regard to the system 100 and the system 300 shown in FIGS. 1-4. Specifically, the detection device 520 identifies a subset of individual light responsive devices 522 that receives the highest light input compared to the other light responsive devices on either the first solar panel array 514 or the second solar panel array 516.

The second satellite 508 also includes a set of thrusters 524, used to position the second satellite 508 such that the optical receiver 506 receives the laser beam 518 by moving the entire second satellite 508, such that the optical receiver 506 is moved relative to the laser beam 518. FIGS. 1-2 and the accompanying description demonstrate a similar system in greater detail. In other embodiments, the optical receiver 506 is moved relative to laser beam 518 in other ways, such as by implementing a system similar to the system 300 shown in FIGS. 3-4 and described above.

In example embodiments, the second satellite 508 also includes a transmitter and the first satellite 504 also includes an optical receiver, thus providing two-way communication. The first satellite 504 also includes the other components necessary to implement a positioning system such as the one described with regard to the second satellite 508 and shown in FIGS. 1-4 and described above. Thus, the first satellite 504 is also configured to reposition its optical receiver using solar panel arrays to guide in targeting.

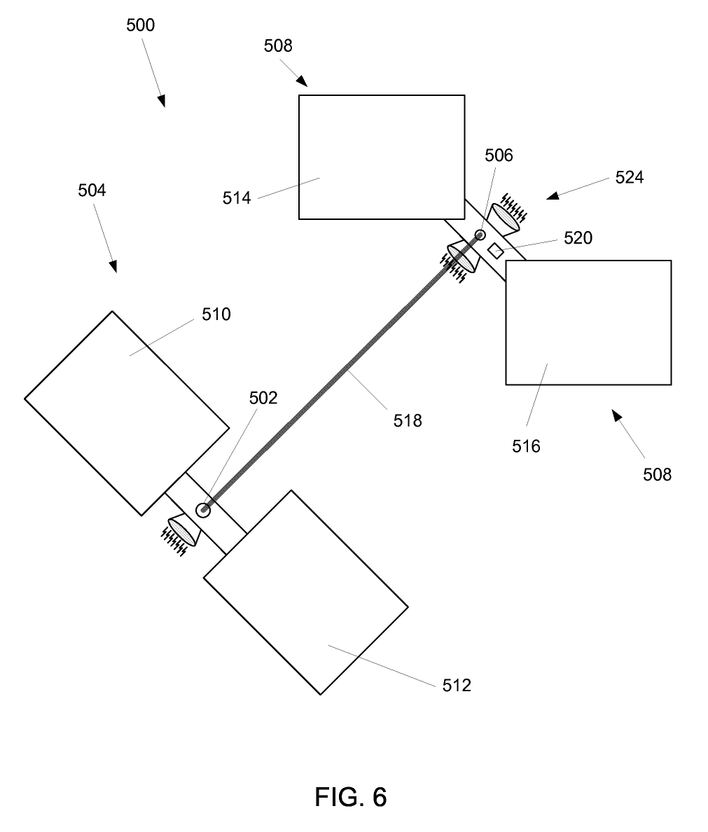

FIG. 6 is a diagram of the laser communication network of FIG. 5 after positioning is completed. The set of thrusters 524 was used to position the second satellite 508 such that the optical receiver 506 receives the laser beam 518 emitted from the first satellite 504. The proper position was determined using the detection device 520 to identify the subset of individual light responsive devices 522 that received the highest light input compared to the other light responsive devices on either the first solar panel array 514 or the second solar panel array 516. Subsequently, the set of thrusters 524 positioned the entire second satellite 508 such that the optical receiver 506 is directly receiving the laser beam 518. In example embodiments, the set of thrusters 524 continues to adjust the position of the entire second satellite 508 to maintain the signal lock on the laser beam 518 by the optical receiver 506.

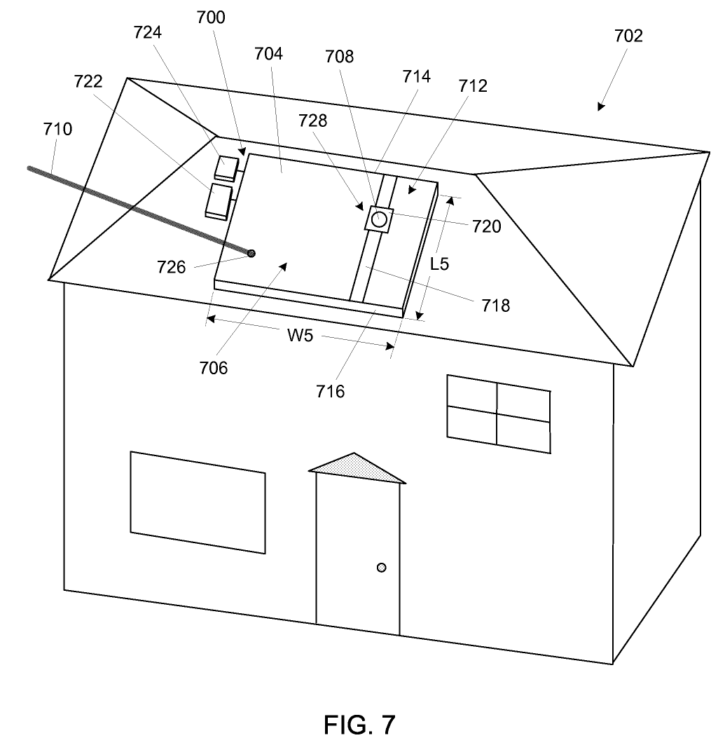

FIG. 7 is a diagram of an embodiment of a laser communication positioning system 700 designed for use on a house or other ground structure. The system 700 is similar to the system 300 shown in FIGS. 3-4, but is implemented as part of a house 702 instead of a satellite 302. In other embodiments, the system 700 is used directly on the ground or on a stand, tower, or other structure placed on the ground. The system 700 includes a first array 704 of light receiving devices, such as a solar cell array. In example embodiments, the first array 704 shown in FIG. 7 has a length L5 of between about 50 centimeters (about 20 inches) and about 12 meters (about 40 feet), but other embodiments of the first array 704 have greater or smaller lengths. The first array 704 shown in FIG. 7 has a width W5 of between about 50 centimeters (about 20 inches) and about 12 meters (about 40 feet), but other embodiments of the first array 704 have greater or smaller widths. Thus, the first array 704 has a target area 706 that is between about 25 square centimeters (about 4 square inches) and about 150 square meters (about 1600 square feet). Other embodiments have a greater or smaller target area 706.

The system 700 also includes an optical receiver 708 configured to receive a laser beam 710 carrying a communication signal. The optical receiver 708 is a light responsive device. In example embodiments, the optical receiver 708 is an optical antenna. The optical receiver 708 is disposed on a track and rail system 712. The track and rail system 712 includes a first track 714 placed on a first side of the first array 704, and a second track 716 placed on a second side of the first array 704 opposite the first side, such that the first track 714 and the second track 716 are parallel with each other. A sliding rail 718 is slidably coupled to the first track 714 on one end and to the second track 716 on the other end.

The track and rail system 712 further includes an optical receiver housing 720 slidably coupled to the sliding rail 718. The optical receiver 708 is disposed in the optical receiver housing 720 and coupled with a signal processing device 722 that processes the communication signal carried in the laser beam 710 received by the optical receiver 708. In some examples, the optical receiver 708 is coupled to the signal processing device 722 through wires or other coupling means embedded in the track and rail system 712. In other examples, the optical receiver 708 is coupled to the signal processing device 722 in other suitable ways that do not restrict movement of the optical receiver 708 in the optical receiver housing 720, such as by wireless radio devices, or with free space optical transmission, such as a laser communication beam. Information received through the communication signal carried in the laser beam 710 is used for any number of purposes, such as for internet data, voice, and television video communication relay. Because of the design of the track and rail system 712 and the optical receiver housing 720, the optical receiver 708 is movable in all directions in the two dimensional plane above the first array 704. In other embodiments, the optical receiver 708 is movable in other directions and on other planes.

The track and rail system 712, including the first track 714, the second track 716, the sliding rail 718, and the optical receiver housing 720 is typically made of strong materials, such as steel, aluminum, titanium, and other metals. In other examples, the track and rail system 712 is made from other suitable materials, such as plastics, carbon fiber, and other composites. The track and rail system 712 is typically as thin and low profile as possible in order to minimize blockage or deflection of sunlight or the laser beam 710. In some embodiments, the first array 704 is configured to be in both opened and closed positions. In these examples, the track and rail system 712 is configured to fold and collapse with the first array 704 when it is in the closed position and to unfold and expand with the first array 704 when it is in the opened position. In other embodiments, the track and rail system 712 includes different numbers of tracks and rails.

The system 700 further includes a detection device 724 coupled with the first array 704 and configured to determine which subset of light responsive devices 726 in the first array 704 receives the greatest light input relative to the other light responsive devices in the first array 704. In some embodiments, the subset of light responsive devices 726 is a single light responsive device. In other embodiments, the subset of light responsive devices 726 is a group of light responsive devices. In some embodiments, the detection device 724 is incorporated into a centralized computing device or implemented in another manner. In some embodiments, the actual location of the subset of light responsive devices 726 on the first array 704 is determined. In other embodiments, the actual location is not explicitly determined, but the subset of light responsive devices 726 is identified in other ways.

The system 700 also includes at least one positioning device 728 configured to position the optical receiver 708 in the optical receiver housing 720. Specifically, the at least one positioning device 728 aligns the optical receiver 708 to receive the laser beam 710, by positioning the optical receiver 708 relative to the subset of light responsive devices 726. In embodiments where the location of the subset of light responsive devices 726 is identified, the at least one positioning device 728 positions the optical receiver 708 at or near the location of the subset of light responsive devices 726. In other embodiments where the location of the subset of light responsive devices 726 is not explicitly identified, the at least one positioning device 728 positions the optical receiver 708 to receive the laser beam 710 in other ways.

In system 700, the at least one positioning device 728 positions the optical receiver 708, by sliding the sliding rail 718 on the first track 714 and the second track 716 and by sliding the optical receiver housing 720 on the sliding rail 718. In example embodiments, the positioning device includes at least one motor configured to move the sliding rail 718 along the first track 714 and the second track 716 and at least one motor configured to move the optical receiver housing 720 along the sliding rail 718. Specifically, a first motor moves the optical receiver housing 720 on the sliding rail 718 and a second and third motor moves the sliding rail along first track 714 and second track 716 respectively. Thus, the optical receiver 708 in the optical receiver housing 720 is configured to be positioned on the two dimensional plane above the above any of the individual light responsive devices in first array 704. In other embodiments, other amounts of motors are used or other devices and mechanisms are provided to reposition the optical receiver 308 in the optical receiver housing 720. In particular embodiments, the at least one positioning device 728 includes a pneumatic or hydraulic system configured to position the optical receiver in the optical receiver housing 720 at various locations in the plane above the first array 704. In some embodiments, the system 700 includes other positioning devices, allowing the optical receiver to pivot or move in other ways.

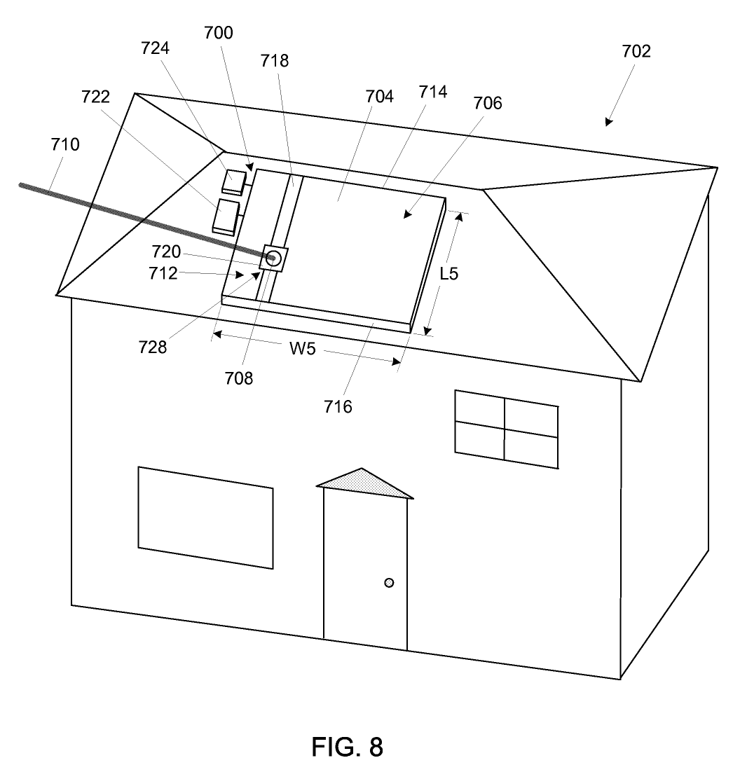

FIG. 8 is a diagram of the laser communication positioning system 700 positioned so that the optical receiver 708 properly receives the laser beam 710. The optical receiver 708 is positioned by at least one positioning device 728 based on the information gathered by the detection device 724. In some examples, the at least one positioning device 728 includes a plurality of motors configured to move the sliding rail 718 along the first track 714 and the second track 716 and to move optical receiver housing 720 along the length of the sliding rail 718. The optical receiver 708 is positioned such that it is intercepts the laser beam 710 striking the subset of light responsive devices 726 in the first array 704 that receives the greatest light input relative to the other light responsive devices in the first array 704. The system 700 will constantly monitor the position of the optical receiver 708 to ensure that it is properly receiving the laser beam 710. Other example embodiments position the optical receiver 708 in other ways, instead of using the track and rail system 712 described above.

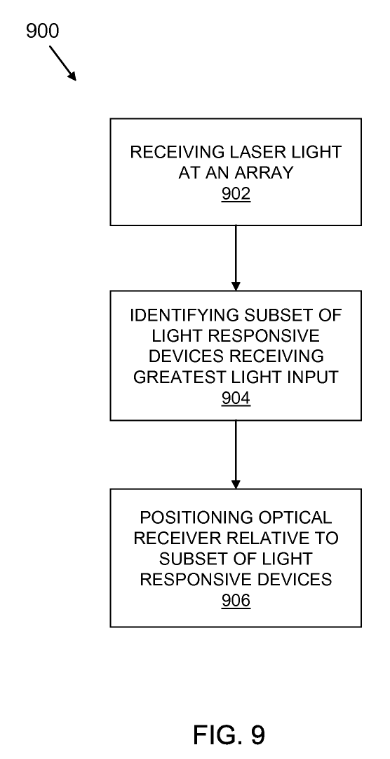

FIG. 9 is a flow chart showing an example embodiment of a method 900 for positioning a laser communication device. Though the method 900 will be described with reference to elements of FIGS. 1-2, in other embodiments the method 900 is implemented using other systems and networks, including, but not limited to those shown in FIGS. 1-8 and described above. The method 900 begins at block 902 where laser light is received at the first array 104 of solar cells. As described above with reference to FIGS. 1-8, the first array 104 includes a plurality of individual light responsive devices. The subset of individual light responsive devices 116 from the first array 104 receives the greatest light input relative to the other light responsive devices in the first array 104.

The method 900 proceeds to block 904 where the subset of individual light responsive devices 116 which receives the greatest light input relative to the other light responsive devices in the first array 104 is identified using the detection device 114. The subset of individual light responsive devices 116 receiving the greatest light input relative to the other light responsive devices in the first array 104 is currently receiving the largest momentary energy collection. Thus, it is determined that the subset of individual light responsive devices 116 receives the most direct stimulation from the laser beam 110 carrying a communication signal. It is desirable to position the optical receiver at or near the location of the subset of individual light responsive devices 116 which receives the greatest light input relative to the other light responsive devices in the first array 104 in order to receive the laser beam 110 carrying the communication signal.

further includes an optical receiver 108 configured to receive a laser beam 110 carrying a communication signal

The method 900 proceeds to block 906 where the optical receiver 108 is positioned to intercept the laser beam 110 by using the identity of the subset of individual light responsive devices 116 which receives the greatest light input relative to the other light responsive devices in the first array 104 and positioning the optical receiver 108 relative to the subset of individual light responsive devices 116. Thus, the optical receiver is aligned to receive the laser beam 110 carrying the communication signal. The positioning of the optical receiver 108 occurs in a number of ways, such as by reorienting the entire satellite 102 relative to a laser beam 110 using the first thruster 120 and the second thruster 122 of FIGS. 1-2 or by repositioning the optical receiver relative to the first array or the entire system using the system of FIGS. 3-4. These two ways of positioning the optical receiver are discussed in further detail above regarding FIGS. 1-6, but other ways are also appropriate.

The systems, networks, and methods described in this disclosure are applicable in a variety of laser (and general optical) communication scenarios, including but not limited to communication between two space based installations, two earth based installations, two lunar installations (or other non-earth ground installations), one earth based installation and one space based installation, one lunar based installation (or other non-earth ground installation) and one space based installation, and one earth based installation and one lunar based installation (or other non-earth ground installation). In example embodiments, the non-earth ground installations are on the moon, another planet, another planet's moon, or another celestial object.

Though the systems, networks, and methods described in this disclosure focused on use of laser beams for the transmission of communication signals, the improved systems, networks, and methods described apply to the positioning of optical receivers and other elements generally, and apply to a range of specific purposes, such as the transfer of communication signals discussed and for power transfer between satellites and ground based stations.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system for receiving an optical communication signal comprising:
a first array of light responsive devices defining a first target area;
a second light responsive device defining a second target area, wherein the second target area is smaller than the first target area;
a detection device coupled to the first array of light responsive devices, the detection device configured to identify at least one individual light responsive device in the first array of light responsive devices receiving the greatest light input relative to other light responsive devices in the first array of light responsive devices; and
a positioning device configured to position the second light responsive device relative to the at least one individual light responsive device, such that the second light responsive device receives the optical communication signal.

2. The system of claim 1 wherein the optical communication signal is a laser.

3. The system of claim 1 wherein the first target area is at least about 50 times larger than the second target area.

4. The system of claim 1 wherein the first array of light responsive devices is an array of solar cells.

5. The system of claim 1 wherein the second light responsive device is an optical antenna.

6. The system of claim 1 wherein the positioning device mechanically reorients the second light responsive device relative to the system.

7. The system of claim 7 wherein the second light responsive device is slidably coupled to the first array by at least one sliding element.

8. The system of claim 1 wherein:
the second light responsive device is coupled to the first array of light responsive devices; and
the positioning device moves the second light responsive device and the first array of light responsive devices together.

9. The system of claim 1 wherein the positioning device is configured to reorient the entire system relative to the optical communication signal.

10. A network comprising:
a receiver configured to receive an optical communication signal, the receiver having:
a first array of light responsive devices defining a first target area;
a second light responsive device defining a second target area, wherein the second target area is smaller than the first target area;
a detection device coupled to the first array of light responsive devices, the detection device configured to identify at least one individual light responsive device in the first array of light responsive devices receiving the greatest light input relative to other light responsive devices in the first array of light responsive devices; and
a positioning device configured to position the second light responsive device relative to the at least one individual light responsive device, such that the second light responsive device receives the optical communication signal; and
a transmitter configured to transmit an optical communication signal, the transmitter having a light emitting device, wherein:
the light emitting device of the transmitter sends the optical communication signal to the receiver;
the optical communication signal is received at the first array of light responsive devices of the receiver;
the detection device determines the identity of the at least one individual light responsive device in the first array of light responsive devices receiving the greatest light input relative to other light responsive devices in the first array of light responsive devices; and
the positioning device uses the identity of the at least one individual light responsive device receiving the greatest light input to position the second light responsive device to receive the optical communication signal.

11. The network of claim 10 wherein the optical communication signal is a laser.

12. The network of claim 10 wherein the first target area is at least about 50 times larger than the second target area.

13. The network of claim 10 wherein the second light responsive device is mechanically positioned.

14. The network of claim 10 wherein the first array of light responsive devices is an array of solar cells.

15. A method for positioning an optical communication device comprising:
receiving an optical communication signal at a first array of light responsive devices defining a first target area;
identifying at least one individual light responsive device in the first array of light responsive devices that receives the greatest light input relative to other light responsive devices in the first array of light responsive devices; and
positioning a second light responsive device, having a second target area smaller than the first target area, relative to the at least one individual light responsive device, such that the second light responsive device receives the optical communication signal.

16. The method of claim 15 wherein the first target area is at least about 50 times larger than the second target area.

17. The method of claim 15 wherein positioning the second light responsive device comprises mechanically moving the second light responsive device.

18. The method of claim 15 wherein the optical communication signal is a laser.

19. The method of claim 15 wherein:
the optical communication device is coupled with a satellite; and
positioning the second light responsive device comprises reorienting the satellite relative to the optical communication signal.

20. The method of claim 15 wherein:
the second light responsive device is slidably coupled to the first array of light responsive devices using a plurality of sliders; and
positioning the second light responsive device includes sliding the second light responsive device to the position corresponding with the individual light responsive device in the first array of light responsive devices that receives the optical communication signal with the greatest intensity compared to the other light responsive devices in the first array of light responsive devices.
